(19) United States
(12) Patent Application Publication
(10) Pub. No.: US 2012/0319640 A1
(43) Pub. Date: Dec. 20, 2012

(54) ELECTRONIC APPARATUS AND METHOD OF SUPPLYING POWER

(75) Inventor: Jeong-gyu PARK, Yongin-si (KR)

(73) Assignee: Samsung Electronics Co., Ltd, Suwon-si (KR)

(21) Appl. No.: 13/301,984

(22) Filed: Nov. 22, 2011

(30) Foreign Application Priority Data
Jun. 14, 2011 (KR) 2011-0057553

(51) Int. Cl. H02J 7/00; G05F 1/635; G05F 1/10

(52) U.S. Cl. 320/101; 323/234; 323/294

(57) ABSTRACT

An electronic apparatus and a method of supplying power. The electronic apparatus includes: a solar cell to convert solar energy into electric energy; a converter to convert and output an output voltage of the solar cell; a temperature compensator to sense the output voltage and a temperature of the solar cell and correct the sensed output voltage of the solar cell according to the sensed temperature of the solar cell; and a controller to perform a feedback control with respect to an output voltage of the converter according to the corrected output voltage of the solar cell.

### CROSS-REFERENCE TO RELATED APPLICATIONS

This application claims the benefit from Korean Patent Application No. 10-2011-0057553, filed on Jun. 14, 2011, in the Korean Intellectual Property Office, the disclosure of which is incorporated herein by reference in its entirety.

### BACKGROUND OF THE INVENTION

1. Field of the Invention

The present general inventive concept generally relates to an electronic apparatus and a method of supplying power, and more particularly, to an electronic apparatus which compensates for a temperature of a solar cell to control a maximum power point, and a method of supplying power.

2. Description of the Related Art

New renewable energy sources, such as wind power, the sunlight, fuel cells, tidal power generation, etc., have been recently greatly increased with the development of green energy sources, obligations to reduce the emission of CO2, and the era of high oil prices.

Among these new renewable energy sources, a solar cell is classified into: 1) a solar heat cell which generates vapor necessary to rotate a turbine by using solar heat; and 2) a sunlight cell which converts the sunlight into electric energy by using a semiconductor property. More commonly, a solar cell refers to a sunlight cell. Hereinafter, a sunlight cell will be referred to as a solar cell.

Since an output of a solar cell is very unstable according to the sunlight environment, etc., a converter apparatus is required to supply the output of the solar cell to an electronic apparatus. The converter apparatus converts output power of the solar cell into stable power. The converter apparatus controls a maximum power point tracking (MPPT) control so that the solar cell generates maximum power.

Power is calculated through a multiplication of a voltage and a current. However, if maximum power of the solar cell is calculated using the multiplication of the voltage and the current, the converter apparatus requires a complicated circuit, and a long time is taken to perform the calculation. Therefore, the conventional converter apparatus performs the MPPT control, which is proportional to the voltage, through a change in the voltage.

The maximum power of the solar cell has a non-linear characteristic with respect to a temperature of the solar cell. However, the conventional converter apparatus requires the complicated circuit, as described above, to compensate for the non-linear characteristic and thus does not compensate for a change in the temperature of the solar cell.

Also, a converter apparatus, which can compensate for a change in a temperature of a solar cell, uses a complicated circuit or a complicated algorithm to compensate for a non-linear temperature characteristic.

### SUMMARY OF THE INVENTION

The present general inventive concept provides an electronic apparatus which compensates for a change in a temperature of a solar cell to control a maximum power point, and a method of supplying power.

Additional embodiments of the present general inventive concept will be set forth in part in the description which follows and, in part, will be obvious from the description, or may be learned by practice of the general inventive concept.

The foregoing and/or other features and utilities of the present general inventive concept may be achieved by an electronic apparatus including: a solar cell to convert solar energy into electric energy; a converter to convert and output an output voltage of the solar cell; a temperature compensator to sense the output voltage and a temperature of the solar cell and to correct the sensed output voltage of the solar cell according to the sensed temperature of the solar cell; and a controller to perform a feedback control with respect to an output voltage of the converter according to the corrected output voltage of the solar cell.

The temperature compensator may include: a plurality of resistors to divide the output voltage of the solar cell; and a thermistor to sense the temperature of the solar cell and to be connected to at least one of the plurality of resistors in parallel.

The thermistor may be a negative characteristic (NTC) thermistor which is connected to one of the plurality of resistors in parallel and has a resistance value decreasing with an increase in the temperature, wherein the one resistor comprises an end which is connected to an output node of the solar cell.

The thermistor may be a positive characteristic (PTC) thermistor which is connected to one of the plurality of resistors in parallel and has a resistance value increasing with an increase in the temperature, wherein the one resistor comprises an end which is connected to the ground.

The thermistor may contact the output node of the solar cell which outputs the output voltage of the solar cell.

The controller may control the converter to operate the solar cell at a maximum power point.

The controller may include: a first comparator to output a difference between the corrected output voltage of the solar cell and a preset first voltage; a second comparator to output a difference between an output voltage of the converter and a preset second voltage; an amplifier to amplify and output an output voltage of the first comparator and an output voltage of the second comparator; and a pulse width modulation (PWM) signal generator to generate a PWM signal, which is to control the converter, by using an output voltage of the amplifier.

The controller may include: a third comparator to output a difference between the corrected output voltage of the solar cell and an output voltage of the converter; an amplifier to amplify and output an output voltage of the third comparator; and a PWM signal generator to generate a PWM signal, which is to control the converter, by using an output voltage of the amplifier.

The controller may include: an amplifier to receive an output voltage of the converter as an offset voltage and to amplify and output the corrected output voltage of the solar cell; and a PWM signal generator to generate a PWM signal, which is to control the converter, by using an output voltage of the amplifier.

The electronic apparatus may further include a cell unit to charge a secondary cell by using an output voltage of the converter.

The foregoing and/or other features and utilities of the present general inventive concept may also be achieved by a method of supplying power in an electronic apparatus which is supplied with power through a solar cell, the method including: sensing an output voltage and a temperature of the solar cell; correcting the sensed output voltage of the solar cell according to the sensed temperature of the solar cell; generating a feedback control signal according to the corrected output voltage of the solar cell; and converting and outputting the output voltage of the solar cell according to the feedback control signal.

The output voltage and the temperature of the solar cell may be sensed by using a plurality of resistors and a thermistor, wherein the plurality of resistors divide the output voltage of the solar cell, and the thermistor is connected to at least one of the plurality of resistors in parallel.

The thermistor may contact an output node of the solar cell which outputs the output voltage of the solar cell.

The generation of the feedback control signal may include generating a PWM control signal to operate the solar cell at a maximum power point.

The method may further include charging a secondary cell by using the converted output voltage of the solar cell.

The foregoing and/or other features and utilities of the present general inventive concept may also be achieved by providing an electronic apparatus, comprising: a converter to convert and output an output voltage of a solar to electric energy converting device; a temperature compensator to sense the output voltage and temperature of the solar to electric energy converting device and to correct the sensed output voltage according to the sensed temperature; and a controller to perform a feedback control with respect to an output voltage of the converter according to the corrected output voltage of the solar to electric energy converting device.

In an exemplary embodiment, the temperature compensator may include a plurality of resisters in series to divide the output voltage of the solar to electric energy converting device; and a variable resistor in parallel with one of the plurality of resisters and which varies a resistance value according to the sensed temperature, the one of the plurality of resisters being connected to an output of the solar to electric energy converting device.

The foregoing and/or other features and utilities of the present general inventive concept may also be achieved by providing a non-transient computer-readable recording medium containing a method of supplying power in an electronic apparatus which is supplied with power through a solar cell, the method comprising: sensing an output voltage and a temperature of the solar cell; correcting the sensed output voltage of the solar cell according to the sensed temperature of the solar cell; generating a feedback control signal according to the corrected output voltage of the solar cell; and converting and outputting the output voltage of the solar cell according to the feedback control signal.

### BRIEF DESCRIPTION OF THE DRAWINGS

These and/or other embodiments of the present general inventive concept will become apparent and more readily appreciated from the following description of the embodiments, taken in conjunction with the accompanying drawings of which:

FIG. 1 is a block diagram of an electronic apparatus according to an exemplary embodiment;

FIG. 2 is a circuit diagram of an electronic apparatus according to an exemplary embodiment;

FIG. 3 is a circuit diagram of an electronic apparatus according to another exemplary embodiment;

FIG. 4 is a circuit diagram of an electronic apparatus according to another exemplary embodiment;

FIG. 5 is a circuit diagram of an electronic apparatus according to another exemplary embodiment;

FIG. 6 is a graph illustrating changes in a maximum power point of a solar cell with respect to changes in a temperature of the solar cell;

FIG. 7 is a view illustrating non-linear compensation graphs of a maximum power point of a solar cell with respect to a temperature;

FIG. 8 is a graph illustrating changes in an output voltage and an output current of a solar cell with respect to changes in a temperature of the solar cell;

FIG. 9 is a view illustrating waveforms of various output voltages of an electronic apparatus according to an exemplary embodiment;

FIG. 10 is a view illustrating a response speed of an electronic apparatus according to an exemplary embodiment; and

FIG. 11 is a flowchart illustrating a method of supplying power according to an exemplary embodiment.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

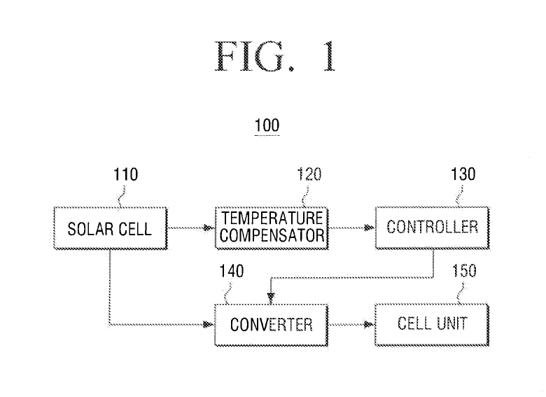

FIG. 1 is a block diagram of an electronic apparatus 100 according to an exemplary embodiment.

Referring to FIG. 1, the electronic apparatus 100 includes a solar cell 110, a temperature compensator 120, a controller 130, a converter 140, and a cell unit 150.

The solar cell 110 converts solar energy into electric energy. In more detail, the solar cell 110 includes P-N junction diodes and converts light energy into electric energy by using a photoelectric effect. The solar cell 110 may include a plurality of solar cells which convert solar energy into electric energy and are connected to one another in series and/or in parallel.

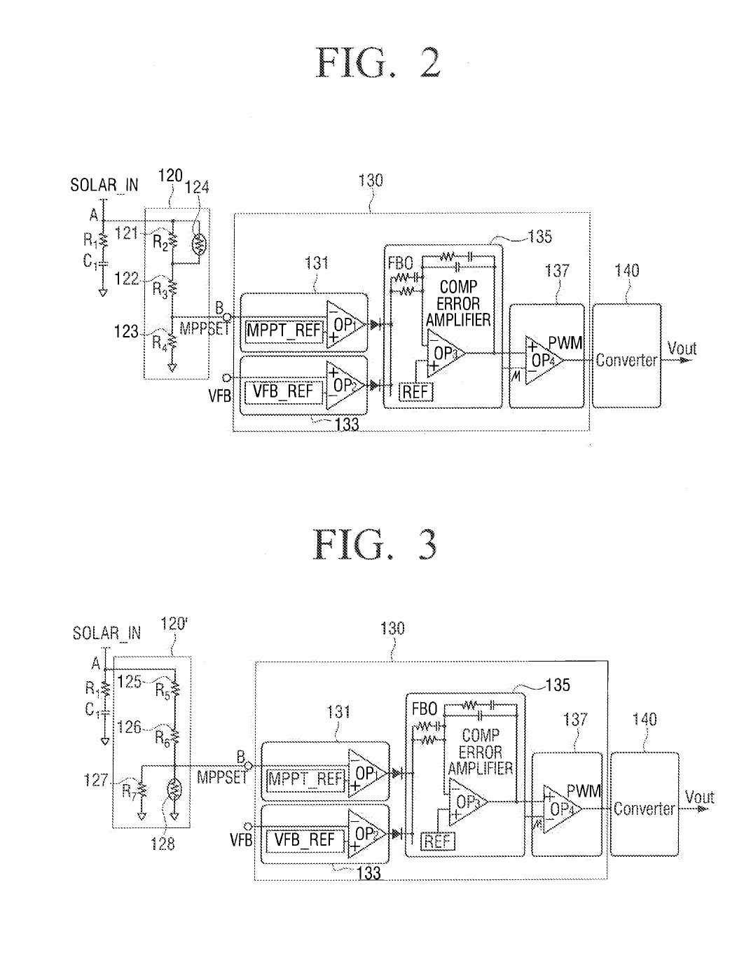

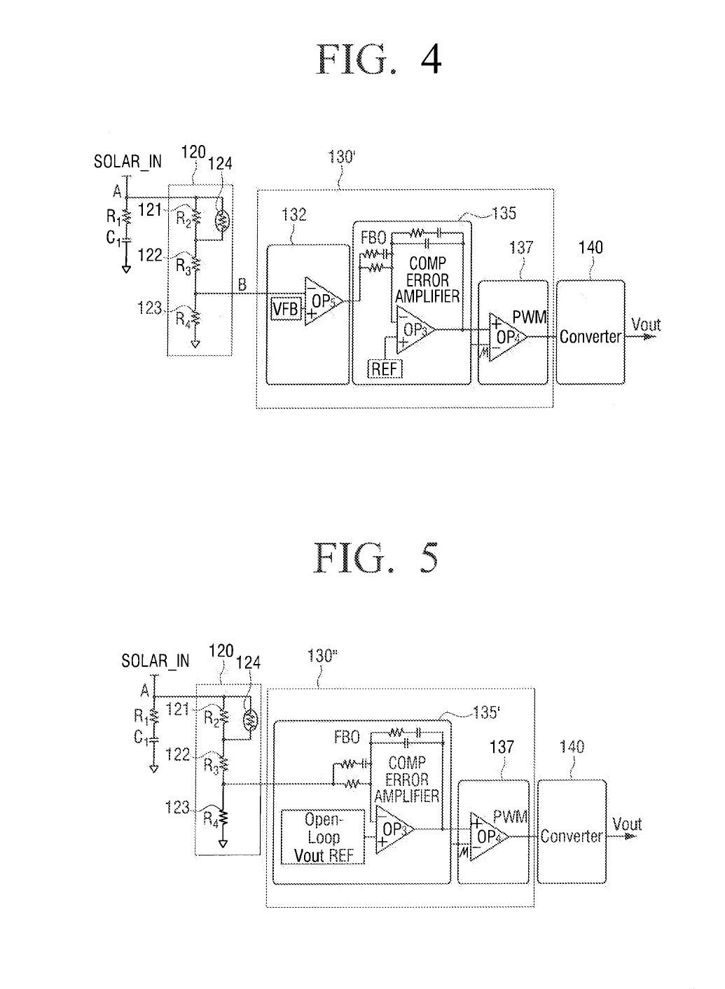

The temperature compensator 120 senses an output voltage and a temperature of the solar cell 110 and corrects the sensed output voltage of the solar cell 110 according to the sensed temperature of the solar cell 110. In more detail, the temperature compensator 120 may include a plurality of resistors which divide the output voltage of the solar cell 110 and a thermistor which senses the temperature of the solar cell 110. Detailed structure and operation of the temperature compensator 120 will be described later with reference to FIGS. 2 and 3.

The controller 130 performs a feedback control with respect to an output voltage of the converter 140 according to the corrected output voltage of the solar cell 110. In more detail, the controller 130 may perform a maximum power point tracking (MPPT) control by using the corrected output voltage of the solar cell 110, which is an output of the temperature compensator 120, and the output voltage of the converter 140, so that the solar cell 110 operates at a maximum power point. Detailed structure and operation of the controller 130 will be described later with reference to FIGS. 2 through 5.

The converter 140 converts and outputs the output voltage of the solar cell 110. In more detail, since an output of the solar cell 110 is very unstable according to the sunlight environments (e.g., clouds, an light radiation angle, etc.), the converter 140 may rectify the output voltage of the solar cell 110. For example, the converter 140 may rectify the output voltage of the solar cell 110 by using an inductor which smoothes a current and a capacitor which smoothes a voltage.

The converter 140 may also adjust the output voltage of the solar cell 110 according to a pulse width modulation (PWM) signal which is generated by the controller 130. The solar cell 110 may operate at the maximum power point through this adjustment.

The cell unit 150 charges a secondary cell by using an output voltage of the converter 140. Here, the secondary cell may be a nickel cell, a cadmium cell, a nickel-cadmium cell, a chemical cell, or the like. Also, the cell unit 150 may supply power to elements of the electronic apparatus 100.

FIG. 2 is a circuit diagram of an electronic apparatus according to an exemplary embodiment.

Referring to FIG. 2, a temperature compensator 120 is connected to an output node A of a solar cell in parallel. The temperature compensator 120 also includes a plurality of resistors 121, 122, and 123 and a thermistor 124.

The plurality of resistors 121, 122, and 123 are connected to the output node A of the solar cell in parallel and are connected to one another in series to divide an output voltage of the solar cell. As shown in FIG. 2, a voltage of a node B to which the third and fourth resistors 122 and 123 are connected is transmitted to a controller 130.

The thermistor 124 contacts the output node A (a physical position) of the solar cell to sense a temperature of the solar cell. Also, the thermistor 124 is electrically connected to the second resistor 121 in parallel. In the present exemplary embodiment, the thermistor 124 contacts only the output node A of the solar cell, but may contact a back surface of the solar cell (an opposite surface of a light incidence part).

Here, the thermistor 124 according to the exemplary embodiment of FIG. 2 may be a negative characteristic (NTC) thermistor which has a resistance value that decreases with an increase in a temperature. Therefore, if a temperature of the solar cell increases without a change in the output voltage of the solar cell, the resistance value of the thermistor 124 decreases, and an output voltage MPPSET of the temperature compensator 120 increases.

Through this operation, the temperature compensator 120 may correct and output a sensed output voltage of the solar cell 110 according to the temperature of the solar cell 110.

The temperature compensator 120 is realized by using a negative characteristic (NTC) thermistor as described with reference to FIG. 2, but may also be realized by using a positive characteristic (PTC) thermistor. This example will be described later with reference to FIG. 3.

The controller 130 includes a first comparator 131, a second comparator 133, an amplifier 135, and a PWM signal generator 137.

The first comparator 131 outputs a difference between the corrected output voltage MPPSET of the solar cell and a preset first voltage MPPT_REF. In more detail, the first comparator 131 may include a first operational amplifier OP1, receive the output voltage MPPSET of the solar cell, which is corrected by the temperature compensator 120, through a negative node of the first operational amplifier OP1, receive the preset first voltage MPPT_REF through a positive node of the first operational amplifier OP1, and amplify and output the difference between the corrected output voltage MPPSET of the solar cell and the preset first voltage MPPT_REF.

The second comparator 133 outputs a difference between an output voltage VFB of the converter 140 and a preset second voltage VFB_REF. In more detail, the second comparator 133 may include a second operational amplifier OP2, receive the output voltage VFB of the converter 140 through a positive node of the second operational amplifier OP2, receive the preset second voltage VFB_REF through a negative node of the second operational amplifier OP2, and amplify and output the difference between the output voltage VFB of the converter 140 and the preset second voltage VFB_REF.

The amplifier 135 may amplify and output an output voltage of the first comparator 131 and an output voltage of the second comparator 133. In more detail, the amplifier 135 may multiply the output voltages of the first and second comparators 131 and 133 by a fixed gain by using a third operational amplifier OP3, a plurality of resistors, and a plurality of capacitors, and output the multiplication result.

The PWM signal generator 137 generates a PWM signal, which is to control the converter 140, by using an output voltage of the amplifier 135. In more detail, the PWM signal generator 137 may include a fourth operational amplifier OP4, receive a triangular wave through a negative node of the fourth operational amplifier OP4, receive the output voltage of the amplifier 135 through a positive node of the fourth operational amplifier OP4, and generate the PWM signal which is to turn on/off a power switch of the converter 140.

As described above, the electronic apparatus 100 according to the present exemplary embodiment compensates for a change in a temperature of a solar cell and controls a maximum power point by using a relatively simple circuit structure.

As described with reference to FIG. 2, the controller 130 is realized by using the first comparator 131, the second comparator 133, the amplifier 135, and the PWM signal generator 137. However, the controller 130 may alternatively be realized in a structure as shown in FIGS. 4 and 5, according to other exemplary embodiments of the inventive concept, or in another structure which performs the intended purposes as described herein.

FIG. 3 is a circuit diagram of an electronic apparatus 100′ according to another exemplary embodiment.

Referring to FIG. 3, the electronic apparatus 100′ according to the present exemplary embodiment has the same structure as the electronic apparatus 100 according to the previous exemplary embodiment of FIG. 2, except for a circuit structure of a temperature compensator 120′. Therefore, descriptions of elements except for the temperature compensator 120′ will be omitted.

The temperature compensator 120′ includes a plurality of resistors 125, 126, and 127 and a thermistor 128.

The plurality of resistors 125, 126, and 127 are connected to an output node A of a solar cell 110 in parallel and are connected to one another in series so as to divide an output voltage of the solar cell. Referring to FIG. 3, a voltage of a node B to which the resistor 125 and the resistor 126 are connected is transmitted to a controller 130.

The thermistor 128 contacts the output node A (a physical position not illustrated) of the solar cell to sense a temperature of the solar cell. Also, the thermistor 128 is electrically connected to the resistor 127 in parallel. In the present exemplary embodiment, the thermistor 128 contacts only the output node A of the solar cell, but may contact a back surface of the solar cell (an opposite surface of a light incidence part).

Here, the thermistor 128 according to the exemplary embodiment of FIG. 3 may be a PTC thermistor which has a resistance value that increases with an increase in a temperature. Therefore, if the temperature of the solar cell increases without a change in an output voltage of the solar cell, the resistance value of the thermistor 128 increases, and an output voltage MPPSET of the temperature compensator 120′ increases.

As described above, the electronic apparatus 100′ according to the present exemplary embodiment may perform a temperature compensation operation as in the exemplary embodiment of FIG. 2, by using a PTC thermistor.

FIG. 4 is a circuit diagram of an electronic apparatus 100″ according to another exemplary embodiment.

Referring to FIG. 4, the electronic apparatus 100″ of the present exemplary embodiment has the same structure as the electronic apparatus 100 of FIG. 2, except for a circuit structure of a controller 130′. Therefore, descriptions of elements except for the controller 130′ will be omitted.

The controller 130′ includes a comparator 132, an amplifier 135, and a PWM signal generator 137.

The comparator 132 outputs a difference between a corrected output voltage MPPSET of a solar cell and an output voltage VFB of a converter 140. In more detail, the comparator 132 may include an operational amplifier OP5, receive the output voltage MPPSET of the solar cell, which is corrected by a temperature compensator 120, through a negative node of the operational amplifier OP5, receive the output voltage VFB of the converter 140 through a positive node of the operational amplifier OP5, and amplify and output the difference between the corrected output voltage MPPSET of the solar cell and the output voltage VFB of the converter 140.

The amplifier 135 amplifies and outputs an output voltage of the comparator 132. In more detail, the amplifier 135 may multiply the output voltage of the comparator 132 by a fixed gain by using an operational amplifier OP3, a plurality of resistors, and a plurality of capacitors and output the multiplication result.

The PWM signal generator 137 generates a PWM signal, which is to control the converter 140, by using an output voltage of the amplifier 135. In more detail, the PWM signal generator 137 may include an operational amplifier OP4, receive a triangular wave through a negative node of the operational amplifier OP4, receive the output voltage of the amplifier 135 through a positive node of the operational amplifier OP4, and generate the PWM signal which is to turn on/off a power switch of the converter 140.

As described above, in the electronic apparatus 100″′ of the present exemplary embodiment, the corrected output voltage of the solar cell 110 is amplified differentially from the output voltage of the converter 140. Therefore, if the corrected output voltage of the solar cell 110 is lowered, a negative input value of the operational amplifier OP3 of the amplifier 135 is increased by the lowered value of the output voltage of the solar cell. As a result, a final output voltage is lowered.

FIG. 5 is a circuit diagram of an electronic apparatus 100″″ according to another exemplary embodiment.

Referring to FIG. 5, the electronic apparatus 100″″ of the present exemplary embodiment has the same structure as the electronic apparatus of FIG. 2 and the electronic apparatus 100″ of FIG. 4, except for a circuit structure of a controller 130″. Therefore, descriptions of elements except for the controller 130″ will be omitted.

The controller 130″ includes an amplifier 135′ and a PWM signal generator 137.

The amplifier 135′ receives an output voltage of a converter 140 as an offset voltage, and amplifies and outputs a corrected output voltage MPPSET of a solar cell. In more detail, the amplifier 135′ may include an operational amplifier OP3, a plurality of resistors, and a plurality of capacitors, receive the output voltage of the converter 140 as a fixed reference value (i.e., open-loop form) through a positive node of the operational amplifier OP3, multiply the corrected output voltage MPPSET of the solar cell by a fixed gain, and output the multiplication result.

The PWM signal generator 137 generates a PWM signal, which is to control the converter 140, by using an output voltage of the amplifier 135′. In more detail, the PWM signal generator 137 may include an operational amplifier OP4, receive a triangular wave through a negative node of the amplifier OP4, receive the output voltage of the amplifier 135′ through a positive node of the operational amplifier OP4, and generate the PWM signal which is to turn on/off a power switch of the converter 140.

As described above, in the electronic apparatus 100″″ of the present exemplary embodiment, the corrected output voltage of the solar cell is input as a negative input of the operational amplifier OP3, and the output voltage of the converter 140 is input as a positive input of the operational amplifier OP3 in an open-loop form of a fixed reference value. Therefore, the corrected output voltage of the solar cell is controlled in an offset form of an error amplification of an output reference. As a result, a final output is corrected according to a temperature to control output power.

As described above, the electronic apparatuses according to the above exemplary embodiments compensate for a change in a temperature of a solar cell and control a maximum power point by using a relatively simple circuit structure.

As described with reference to FIGS. 1 through 5, a temperature of a solar cell is measured by using a thermistor. However, a temperature compensator as described above may be realized by using another type of temperature sensing element which has a resistance value that changes with a change in a temperature.

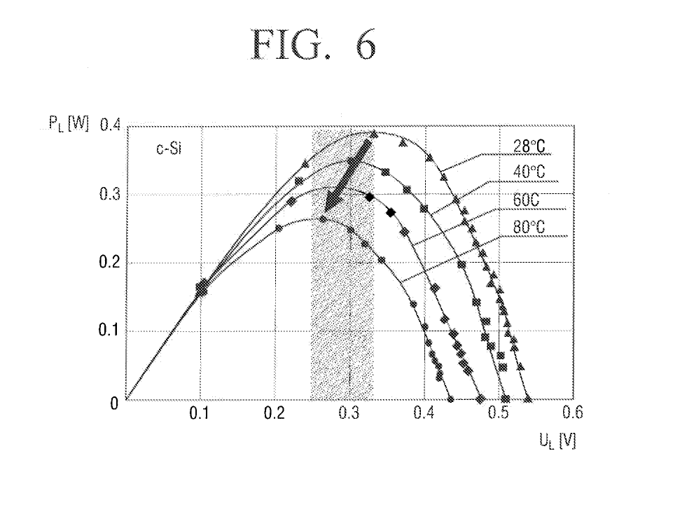

FIG. 6 is a graph illustrating changes in a maximum power point of a solar cell with respect to changes in a temperature of the solar cell.

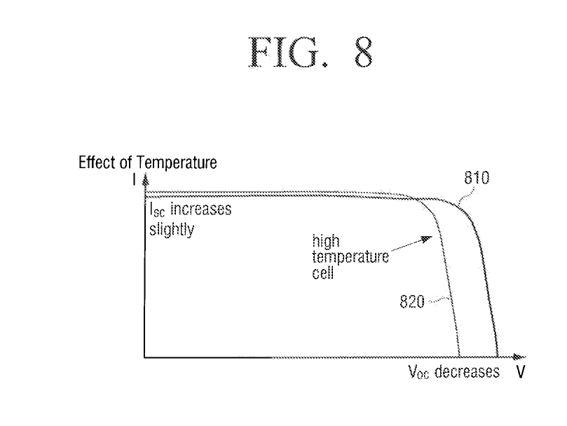

Referring to FIG. 6, the solar cell has a maximum output which is non-linear with respect to the temperature. In more detail, the solar cell 110 has a non-linear characteristic in which a voltage greatly decreases and a current slightly increases with an increase in a temperature as shown in FIG. 8. Therefore, the solar cell has a maximum output which is non-linear with respect to the temperature.

Accordingly, in the present exemplary embodiment, as described above, the non-linear characteristic of the solar cell with respect to the temperature is compensated for by using a thermistor which has a resistance characteristic that changes with a change in the temperature.

Also, as described above, an electronic apparatus according to the present exemplary embodiment may compensate for the non-linear characteristic of the solar cell with respect to the temperature by using a relatively simple circuit structure. In other words, differently from the related art, the non-linear characteristic of the solar cell with respect to the temperature may be compensated for without an analog-to-digital converter (ADC), which is to sense the temperature of the solar cell in a control circuit, and a complicated operational process performed according to the sensed temperature.

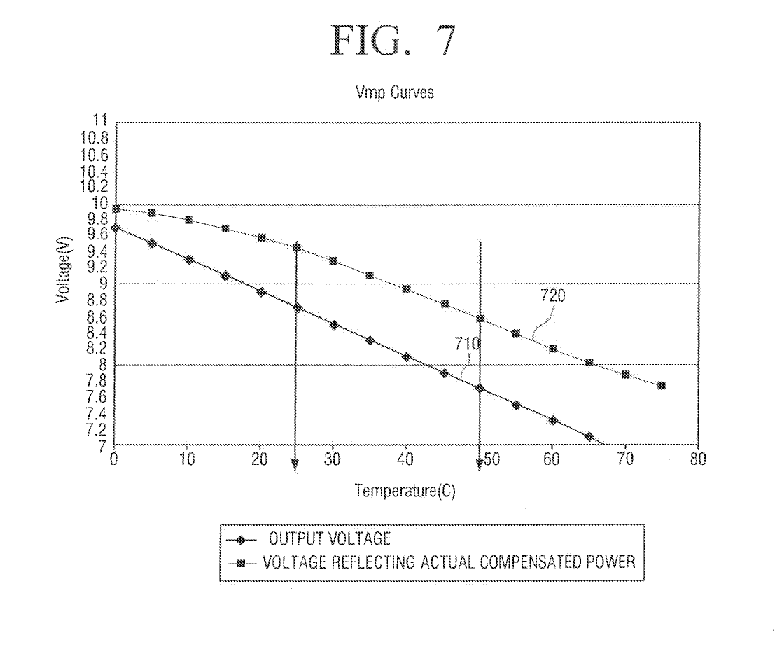

FIG. 7 is a view illustrating non-linear compensation graphs of a maximum power point of a solar cell with respect to a temperature.

In more detail, a graph 710 illustrates changes in an output voltage of the solar cell 110 if a temperature of the solar cell is not compensated for, and a graph 720 illustrates changes in the output voltage of the solar cell if the temperature of the solar cell is compensated for.

Referring to FIG. 7, an electronic apparatus according to the present exemplary embodiment reflects a non-linear characteristic with respect to a temperature to perform an MPPT control.

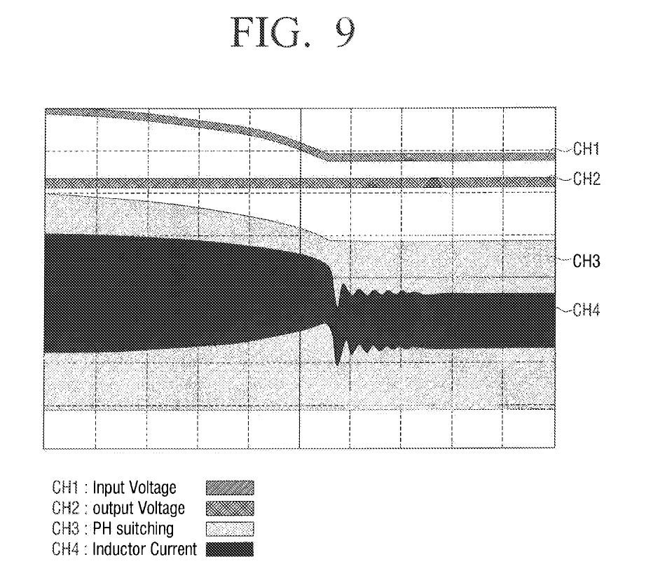

FIG. 9 is a view illustrating waveforms of various output voltages in an electronic apparatus according to an exemplary embodiment.

Here, a waveform CH1 indicates an output voltage of the solar cell 110, and a waveform CH2 indicates an output voltage of the converter 140.

Referring to FIG. 9, even if a small amount of light is incident onto the solar cell 110, and thus the output voltage of the solar cell 110 decreases, an MPPT control is performed to rapidly reduce an output current (an output current of the converter 140) in order to maintain a stable output.

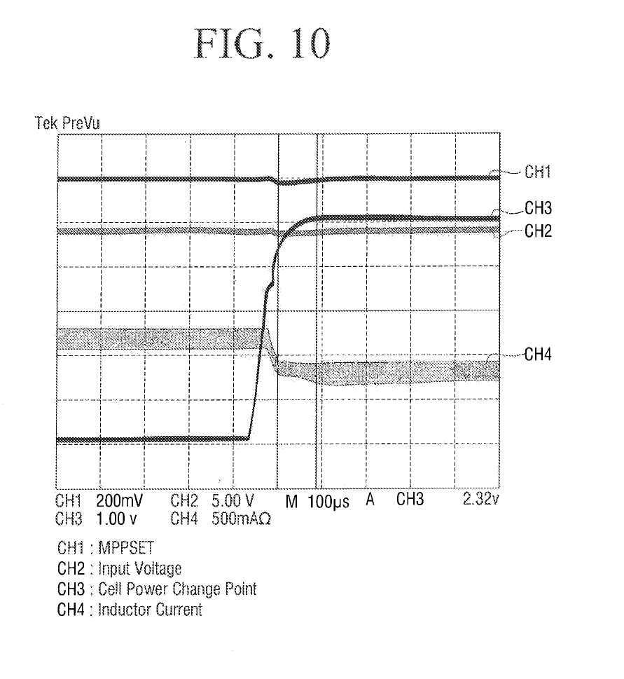

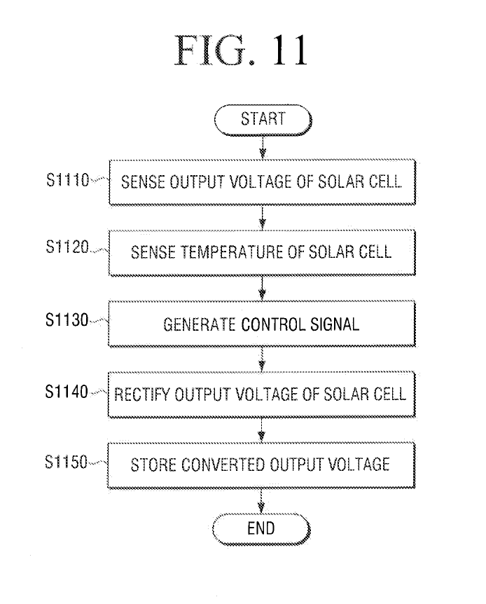

FIG. 10 is a view illustrating a response speed of the electronic apparatus 100 according to an exemplary embodiment.

Here, a waveform CH1 indicates an output voltage of the temperature compensator 120, i.e., an output voltage of the solar cell 110 which is corrected according to a temperature of the solar cell 110. A waveform CH2 indicates an output voltage of the solar cell 110, a waveform CH3 is a trigger signal indicating changes in the output voltage of the solar cell 110, and a waveform CH4 indicates a PWM signal which is generated by the controller 130.

Referring to FIG. 10, even if the output voltage of the solar cell 110 decreases according to changes in light incident onto the solar cell 110, the electronic apparatus performs a MPPT control at a high response speed of about 5 μs.

FIG. 11 is a flowchart illustrating a method of supplying power according to an exemplary embodiment.

Referring to FIG. 11, in operation S1110, an output voltage of a solar cell is sensed. In operation S1120, a temperature of the solar cell is sensed. In more detail, the output voltage and the temperature of the solar cell may be sensed by using a plurality of resistors which divide the output voltage of the solar cell and a thermistor which is connected to at least one of the plurality of resistors in parallel. The sensed output voltage of the solar cell may be compensated for together with the sensing operation according to the sensed temperature of the solar cell.

In operation S1130, a feedback control signal is generated according to the corrected output voltage of the solar cell. Operation S1130 of generating the feedback control signal, i.e., a PWM signal, according to the corrected output voltage of the solar cell has been described with reference to FIGS. 2 through 5, and thus repeated descriptions will be omitted.

In operation S1140, the output voltage of the solar cell is converted and output according to the feedback control signal. In more detail, the output voltage of the solar cell may be rectified so as to be stably supplied to an electronic apparatus. Also, an output current of the solar cell may be converted according to the feedback control signal so that the solar cell operates at a maximum power point.

In operation S1150, a secondary cell is charged by using the converted output voltage of the solar cell. Here, the secondary cell may be a nickel cell, a cadmium cell, a nickel-cadmium cell, a chemical cell, or the like. Power which has been charged into the secondary cell may be supplied to elements of the electronic apparatus.

Accordingly, the method according to the present exemplary embodiment may compensate for changes in a temperature of a solar cell and perform a MPPT control by using a relatively simple circuit structure. The method of FIG. 11 may be executed by an electronic apparatus having a structure as described with reference to FIG. 1 or electronic apparatuses having other structures.

The present general inventive concept can also be embodied as computer-readable codes on a non-transient computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains

Although various example embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. An electronic apparatus comprising:
a solar cell to convert solar energy into electric energy;
a converter to convert and output an output voltage of the solar cell;
a temperature compensator to sense the output voltage and a temperature of the solar cell and to correct the sensed output voltage of the solar cell according to the sensed temperature of the solar cell; and
a controller to perform a feedback control with respect to an output voltage of the converter according to the corrected output voltage of the solar cell.

2. The electronic apparatus as claimed in claim 1, wherein the temperature compensator comprises:
a plurality of resistors to divide the output voltage of the solar cell; and
a thermistor to sense the temperature of the solar cell and to be connected to at least one of the plurality of resistors in parallel.

3. The electronic apparatus as claimed in claim 2, wherein the thermistor is a negative characteristic (NTC) thermistor which is connected to one of the plurality of resistors in parallel and has a resistance value that decreases with an increase in the temperature, wherein the one resistor comprises an end which is connected to an output node of the solar cell.

4. The electronic apparatus as claimed in claim 2, wherein the thermistor is a positive characteristic (PTC) thermistor which is connected to one of the plurality of resistors in parallel and has a resistance value that increases with an increase in the temperature, wherein the one resistor comprises an end which is connected to the ground.

5. The electronic apparatus as claimed in claim 2, wherein the thermistor contacts the output node of the solar cell which outputs the output voltage of the solar cell.

6. The electronic apparatus as claimed in claim 1, wherein the controller controls the converter to operate the solar cell at a maximum power point.

7. The electronic apparatus as claimed in claim 1, wherein the controller comprises:
a first comparator to output a difference between the corrected output voltage of the solar cell and a preset first voltage;
a second comparator to output a difference between an output voltage of the converter and a preset second voltage;
an amplifier to amplify and output an output voltage of the first comparator and an output voltage of the second comparator; and
a pulse width modulation (PWM) signal generator to generate a PWM signal, which is to control the converter, by using an output voltage of the amplifier.

8. The electronic apparatus as claimed in claim 1, wherein the controller comprises:
a third comparator to output a difference between the corrected output voltage of the solar cell and an output voltage of the converter;
an amplifier to amplify and output an output voltage of the third comparator; and
a PWM signal generator to generate a PWM signal, which is to control the converter, by using an output voltage of the amplifier.

9. The electronic apparatus as claimed in claim 1, wherein the controller comprises:
an amplifier to receive an output voltage of the converter as an offset voltage and to amplify and output the corrected output voltage of the solar cell; and
a PWM signal generator to generate a PWM signal, which is to control the converter, by using an output voltage of the amplifier.

10. The electronic apparatus as claimed in claim 1, further comprising a cell unit to charge a secondary cell by using an output voltage of the converter.

11. A method of supplying power in an electronic apparatus which is supplied with power through a solar cell, the method comprising:
sensing an output voltage and a temperature of the solar cell;
correcting the sensed output voltage of the solar cell according to the sensed temperature of the solar cell;
generating a feedback control signal according to the corrected output voltage of the solar cell; and
converting and outputting the output voltage of the solar cell according to the feedback control signal.

12. The method as claimed in claim 11, wherein the output voltage and the temperature of the solar cell are sensed by using a plurality of resistors and a thermistor, wherein the plurality of resistors divide the output voltage of the solar cell, and the thermistor is connected to at least one of the plurality of resistors in parallel.

13. The method as claimed in claim 12, wherein the thermistor contacts an output node of the solar cell which outputs the output voltage of the solar cell.

14. The method as claimed in claim 11, wherein the generation of the feedback control signal comprises generating a PWM control signal to operate the solar cell at a maximum power point.

15. The method as claimed in claim 11, further comprising charging a secondary cell by using the converted output voltage of the solar cell.

16. A non-transient computer-readable recording medium containing a method of supplying power in an electronic apparatus which is supplied with power through a solar cell, the method comprising:
sensing an output voltage and a temperature of the solar cell;
correcting the sensed output voltage of the solar cell according to the sensed temperature of the solar cell;
generating a feedback control signal according to the corrected output voltage of the solar cell; and
converting and outputting the output voltage of the solar cell according to the feedback control signal.
